(19) United States
(12) Patent Application Publication
(10) Pub. No.: US 2024/0237808 A1
(43) Pub. Date: Jul. 18, 2024

(54) CONTAINER AND RELATED PRODUCTION METHOD

(71) Applicant: O.M.Z. OFFICINA MECCANICA ZANOTTI S.p.A., Crema (Cremona) (IT)

(72) Inventor: Pietro PEROLINI, Crema (Cremona) (IT)

(21) Appl. No.: 18/561,991

(22) PCT Filed: Jun. 28, 2021
(86) PCT No.: PCT/IT2021/000030

§ 371 Date: Nov. 17, 2023

(51) Int. Cl. A45D 40/26; B23B 1/00; B23P 15/00

(52) U.S. Cl. CPC A45D 40/265; A45D 40/264; B23B 1/00; B23P 15/00

(57) ABSTRACT

Container in particular for cosmetic or pharmaceutical products and related production method wherein at least one bar is provided which is made of metal or metal alloy, said bar being turned to obtain a main body having a substantially tubular shape and internally defining a compartment for housing the cosmetic or pharmaceutical product, and a closing body having a substantially tubular shape and having an engagement opening associable with an access opening to the compartment defined in said main body; said container being uniquely made of metal or metal alloy.

The present invention relates to a container and related production method.

In particular, the present invention relates to a container, and related production method, preferably used in the cosmetic or pharmaceutical field for the containment of liquid, semi-liquid or pasty products, as for example mascara.

It should be specified that the present invention is however applied in multiple contexts in which it is necessary to provide a container for products that must not be polluted or tampered with by the containment material.

As known, containers for cosmetic products, consist of a substantially cylindrical body, generally made of plastic and defining internally a containment chamber of the same product.

The body has a closed bottom end and an open upper end for accessing the containment chamber of the product. From the open end a threaded collar generally emerges for the coupling of a respective closing plug. The plug can in turn be associated with an applicator (for example a brush or a blade), immersed in the product in the closed condition of the container, and suitable for retaining the cosmetic product and distribute it on the affected part.

The body also has an outer surface properly shaped and provided with writing, logos or other chromatic/ornamental effects suitable to give the whole product a particular aesthetic effect.

Such an aesthetic effect is however limited to the structure and material of the cylindrical body. In this respect, it should be considered that the plastic material used for the production of the body must necessarily have specific characteristics suitable not to alter the chemical composition of the product contained in the body itself, shall be the product impaired.

Consequently, the selection of materials is limited, as well as the possibility of obtaining different aesthetic effects.

For this reason, containers made up of several elements made of materials suitably chosen for their function, are provided.

In this way, while the cylindrical body can be made of a material suitable for containing the cosmetic product but without any particular aesthetic features (plastic material), the cover element is specially designed to give a greater ornamental value to the entire product.

Accordingly, cover elements also having a predominantly cylindrical conformation and being internally hollow to hold the body are manufactured.

These elements are made of metallic material (or similar materials) which can have multiple solutions in terms of external colouring or shaping.

To obtain the desired shape, the cover elements are obtained by a moulding or drawing process starting from a sheet of metal material.

In particular, according to the shape to be obtained, the moulds are properly arranged to plastically deform the metal sheet, thus obtaining the internally hollow cylindrical conformation. In addition, this process allows to obtain ornamental patterns raised on the outer surface of the cover element.

However, this method, although capable of obtaining cover elements provided with particular ornamental effects, has important drawbacks.

It should be considered that a sheet of very thin metal is used to facilitate the aforementioned shaping moulding or drawing processes of the element. In this way, the plastic deformation of the sheet takes place in a quicker and simpler way, and thus becomes much less expensive.

However, the use of a very thin sheet appears to be limiting in terms of material selection and for the production of very different products and which may also require higher thicknesses of the container.

It should also be considered that the printing of the cover element is a non-versatile process, as it involves the production of suitably shaped moulds.

Consequently, for each modification in the shaping of the cover element, it is associated a change of the respective moulds with the resulting disadvantages in terms of general costs of production of each container.

A further important drawback of the known containers described above derives precisely from the difficulty in disposing of the container composed of materials of different nature.

The increasingly stringent regulations in terms of environmental sustainability, in fact, impose the need to use easily disposable and recyclable containers. In this context, the presence of more metallic and plastic materials requires to separate the container at the end of its use in order to provide for its own disposal.

Moreover, the presence of plastic does not ensure the total recyclability of the container with the consequent drawbacks in terms of the ability of recovering of the raw material.

Object of the present invention is therefore to provide a container and related production method which is capable of solving the above-mentioned problems.

In the first place, an object of the present invention is to provide a container and related production method which can be easily disposable of since it is made of a single material, thus eliminating plastic, glass or other materials that are not totally recyclable.

A further object of the present invention is to provide a production method of containers for cosmetic or pharmaceutical products that is versatile and capable of being adaptable, in a simple and cheap way, to the various aesthetic characteristics that the container must exhibit.

In addition, it is an object of the present invention to provide a method that is simple, fast, and able to eliminate the costs of producing moulds.

The mentioned technical task and the specified objects are substantially achieved by a container and related production method comprising the technical specifications set out in one or more of the appended claims.

Further characteristics and advantages of the present invention will become more apparent from the exemplary, and therefore non-limiting, description of a preferred, yet not exclusive, embodiment of a container and related production method of the type illustrated in the appended drawings, wherein:

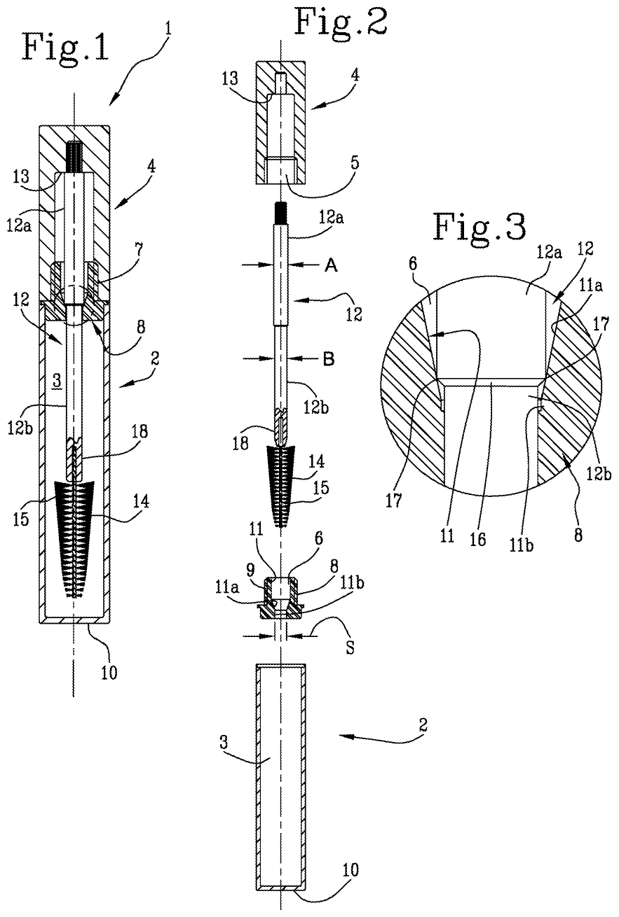

FIG. 1 shows a longitudinal sectional view of a container according to the present invention;

FIG. 2 shows a longitudinal sectional and exploded view of the container of FIG. 1; and

FIG. 3 shows an enlarged view of a construction detail of the container of FIG. 1.

With reference to the appended figures, reference numeral 1 refers, as a way of example, to a container especially for cosmetic or pharmaceutical products according to the present invention.

It should be specified that the container 1 of the present invention can be used in any field and is advantageously used for containing liquid or pastry products, which must not be contaminated by the containment material.

Typically, these technical fields are just cosmetic and pharmaceutical. In particular, containers 1 are for cosmetic use, as for example mascara, as illustrated in the accompanying figures.

The container 1 comprises a main body 2 having a substantially tubular shape and internally defining a compartment 3 for housing the cosmetic product (or pharmaceutical or other product of different nature).

A closing body 4 having a substantially tubular shape and having an engagement opening 5 is also provided. This engagement opening 5 can advantageously be associated with an access opening 6 to the compartment 3 defined in the main body 2.

In order to make the engagement between the closing body 4 and the main body 2 possible, reversible closing means 7 are also provided, arranged in the engagement opening 5 and in the said access opening 6 to associate/dissociate the closing body 4 from the main body 2.

As will be made clearer in the following description, the main body 2, the closing body 4 and the closing means 7 are uniquely made of metal, preferably aluminium alloy.

Advantageously, the material of the entire container 1 is commercially called aluminium alloy EN AW6026LF without lead. This material was chosen for its lathe workability features and for its ability not to interfere with the chemical characteristics of the products contained within the compartment 3. Moreover, this material is completely and totally recyclable.

Also in this case, the aluminium alloy described above is indicated purely by way of an example and therefore without limitation. Other materials with equivalent recyclability and lathe workability features can be used provided they are compatible with the product to be contained.

The main body 2 further comprises a neck 8 defining the aforementioned access opening 6 to the compartment 3. In this context, the closing means 7 preferably consist of a thread 9 formed on the outer surface of the neck 8 and on the inner surface of the closing body 4 at the engagement opening 5.

In this way the closing body 4 can be screwable/unscrewable onto the neck 8 to define the engagement/disengagement of the closing body 4 itself on the main body 2.

Other reversible closing systems, for example snap and mechanical interference, can be provided for the present container 1.

The neck 8 is made separately to the main body 2 and is engaged to the body 2 itself by mechanical interference or by screwing.

The neck 8 defines the access opening 6 having a passage section “S” smaller than the cross-section of the compartment 3.

In more detail, the neck 8 comprises an internal “funnel” shape defining a internal conical surface 11 having a decreasing cross section in a direction towards the main body 2.

In more detail, the internal conical surface 11 presents a first section 11a inclined with respect to the longitudinal extension of the neck 8 and presenting said decreasing cross section, and a second section 11b parallel to the longitudinal extension of the neck 8 and presenting a constant section. The second section 11b is arranged proximally with respect the main body 2 and defining the passage section “S” of the opening 6.

The main body 2 comprises a closed end 10 opposite to the access opening 6.

Preferably, the coupling by mechanical interference of the neck 8 onto the main body 2 ensures a stable engagement.

Advantageously, also the neck 8, although formed in a separate body, is obtained with the same material as the main body 2 and the closing body 4.

As illustrated in the figures, a rod 12 is also provided, also made with the same material obtained for the closing body 4 and for the main body 2.

The rod 12 is constrained by mechanical interference or by screwing to a bottom wall 13 of the closing body 4 opposite to the engagement opening 5.

The rod 12 extends at least partially inside the neck 8 and through the aforementioned passage section “S”.

In particular, it is to be noted that the rod 12 presents a variable cross section along the respective longitudinal extension.

In more detail, the rod 12 comprises a first section 12a next to the closing body 4 and presenting a cross section “A” greater than the cross section “B” of a second section 12b distal from the closing body 4.

The first and the second sections 12a, 12b are adjacent to each other and develop seamlessly along the same longitudinal development.

In this situation, the cross section “A” of the first section 12a is larger than the passage section “S”. The cross section “B” of the second section 12b is smaller than the passage section “S”.

Therefore, the second section 12b is insertable through the opening 6 wile the second section, larger than the passage “S”, cannot be insertable through the opening 6.

It is to be noted that the rod 12 also comprises a conical surface 16 arranged between the first and second section 12a, 12b.

In particular, the conical surface 16 defines an inclined wall matching the conical surface 11 of the neck 8 (FIG. 3) when the second section 12b is inserted in the main body 2.

The dimension of the conical surface 16 of the rod 12 are substantially equal to the dimension of the conical surface 11 next to the second section 11b. This conical coupling between the two surfaces 11, 16 defines an annular contact point 17 (FIG. 3) between rod 12 and neck 8 providing a fluid-tight closure.

In other words, the contact point 17 ensures that the product is retained inside the compartment 3, avoiding accidental spillage of the product outside the compartment 3.

Moreover, the contact point 17 isolates the compartment 3 avoiding the exchange of gases and fluids that can compromise the characteristics of the cosmetic product.

Advantageously, the rod 12 has a free end 18 opposite to the aforementioned bottom wall 13 and on which is associated a metal wire 14 for supporting a plurality of fibres 15.

In particular, the metal wire 14 is braided on itself to constrain the aforementioned fibres 15, preferably made of plant material, and define an eyelash brush.

The metal wire is also made of the same material as the previously mentioned components.

The fibres 15 exhibit a greater transversal development of the passage section “S” of the neck to deform at the outlet of the compartment 3 and release excess product on the undercut of the neck 8 which defines the access opening 6.

As described above, it should be noted that each component of the container 1, i.e. main body 2, closing body 4, neck 8, plug 11 and rod 12, is made of the same material preferably starting from at least one aluminium alloy bar.

Therefore, the container does not present any other material, such as for example plastic or glassy material. The fibres 15 are the only material that differs from the aluminium alloy. Note however that these fibres 15, by their very nature, are easily removable and have a very low environmental impact.

The present invention also relates to a production method of container 1, of the type described above in a predominantly structural sense.

It should be specified that the container 1 can be obtained by any production technique while maintaining the advantages deriving from the presence of a single totally recyclable material.

Preferably, the container 1 can be made by the steps of providing at least one bar made of metal or metal alloy, preferably lead-free aluminium alloy, and turning the bar to obtain: the main body 2 described above and the closing body 4 also mentioned above.

Subsequently, the two bodies 2, 4 are anodized to obtain a surface finish processing.

Also in this case, the surface finish processings can be any, in function of the various production requirements. For example, the container 1 can be painted, printed, subjected to sublimation operations, screen printing, mechanical deformation, pad printing, etc.

The turning step comprises the sub-steps of: turning an inner area of the bar to define the compartment 3 of the main body 2 having a cylindrical shape and the access opening 6 to the compartment; and turning an outer surface of the bar to define an outer shape of the main body 2.

Similarly, the turning step further comprises the sub-steps of: turning an inner area of the bar to define the engagement opening 5 of the closing body 4; and turning an outer surface of the bar to define an outer shape of the closing body 4.

Advantageously, the closing body 4 and the main body 2 can be obtained starting from the same bar or from different bars but of the same material.

The step of turning an inner area of the bar also defines a closed end 10 of the main body 2 opposite to the access opening 6.

In this case, the step of turning the bar further comprises the step of producing the neck 8 of the main body 2 separately and constraining the neck 8 to the access opening 6 of the main body 2 by mechanical interference or by screwing.

Alternatively, the step of turning an inner area of the bar also defines an open end of the main body 2 opposite to the access opening 6. In this case, the neck 8 of the main body can be integrally formed with the body 2 itself.

Furthermore, the method further comprises the step of producing a thread on a cylindrical outer surface of the neck 8 and producing a thread on the engagement opening 5 of the closing body 4.

The step of turning the bar further comprises the step of producing the rod 12 and constraining the rod 12 to a bottom wall 13 of the closing body 4 opposite to the engagement opening 5 by mechanical interference.

At the end of the above-described steps, or in any case, once the bars are turned to obtain all the components of the container 1, further surface processing steps may be provided for applying writings or other ornamental patterns on the respective outer surfaces.

The above-disclosed production method and the container 1 thus obtained have important advantages.

First of all, as mentioned above, the container 1 is made of a single material that can be easily disposable of and completely recyclable.

This advantage is derived from the use of a single material (aluminium alloy) to obtain all the components of the container 1. Note that the material used has remarkable qualities in terms of environmental sustainability and lathe workability. Moreover, this material is able to not alter the chemical and structural features of the product contained in the compartment and has very versatile features in terms of adaptability to the various surface finishes.

Moreover, the turning steps starting from full bars allows to adapt the production of the single container 1 to the different production requirements.

In fact, the method does not require the arrangement of moulds, but only the programming of suitable turning steps to produce products having any shapes.

In other words, the turning step of the bars turns out to be simple and very low in cost as it does not involve the study, preparation and design and production of moulds and does not necessarily have to be performed with metal sheets of predetermined thickness. Consequently, this step is very versatile in that it allows the external shaping of the container 1 to be adapted and modified in a simple and therefore inexpensive manner even for low quantities.

1. Method for the production of a container especially for cosmetic or pharmaceutical products, comprising the steps of:
providing at least a bar made of metal or metal alloy and
turning said bar to obtain:
a main body (2) having a substantially tubular shape and internally defining a compartment (3) for housing the cosmetic or pharmaceutical product,
a closing body (4) having a substantially tubular shape and having an engagement opening (5) associable with an access opening (6) to the compartment defined in said main body (2), and
anodising said main body (2) and said closing body (4) to obtain a surface finish processing;
characterized in that said step of turning the bar further comprises the step of producing a rod (12) and constraining the rod (12) by mechanical interference to a bottom wall (13) of the closing body (4) opposite to the engagement opening (5); said rod (12) extending inside a neck (8) of the main body (2) and defining a contact point (17) with the neck (8) providing a fluid-tight closure of the compartment (3).

2. Method according to the preceding claim, characterized in that said turning step comprises the sub-steps of:
turning an inner area of the bar to define said compartment (3) of the main body (2) having a cylindrical shape and said access opening (6) to the compartment (3); and
turning an outer surface of the bar to define an outer template of the main body (2).

3. Method according to any of the preceding claims, characterized in that said turning step comprises the sub-steps of:
turning an inner area of the bar to define the engagement opening (5) of the closing body (4); and
turning an outer surface of the bar to define an outer template of the closing body (4).

4. Method according to any one of the preceding claims, characterized in that said closing body (4) and said main body (2) are obtained from a same bar.

5. Method according to any one of the preceding claims, characterized in that said step of turning an inner area of the bar further defines a closed end (10) of the main body (2) opposite to the access opening (6);
and in that said step of turning the bar further comprises the step of producing the neck (8) of the main body (2) and constraining the neck (8) to the access opening (6) or the main body (2) by mechanical interference or by screwing.

6. Method according to claim 5, characterized in that it further comprises the step of producing a thread (9) on an cylindrical outer surface of the neck (8) of the main body (2) and producing a thread (9) on the engagement opening (5) of the closing body (4); said closing body (4) being screwable onto said neck (8) of the main body (2).

7. Method according to claim 1, characterized in that it further comprises the step of applying a series of fibres (15) to a free end (12a) of the rod (12) opposite to said bottom wall (13).

8. Container especially for cosmetic or pharmaceutical products, comprising:
a main body (2) having a substantially tubular shape and internally defining a compartment (3) for housing the cosmetic or pharmaceutical product;
a closing body (4) having a substantially tubular shape and having an engagement opening (5) associable with an access opening (6) to the compartment (3) defined in said main body (2);
reversible closing means (7) arranged in said engagement opening (5) and in said access opening (6) to associate/dissociate the closing body (4) with respect to the main body (2);
said main body (2) comprises a neck (8) defining said access opening (6) to the compartment (3), said closing means (7) comprise a thread (9) formed on the outer surface of the neck (8) and on the inner surface of the closing body (4) at the engagement opening (5);
a rod (12) constrained by mechanical interference or by screwing to a bottom wall (13) of the closing body (4) opposite to the engagement opening (5); said rod (12) extending at least partially inside the neck (8) and having a cross-section
characterized in that said closing body (4), said main body (2), said neck (8) and said rod (12) are solely made of aluminium alloy.

9. Container according to claim 8, characterized in that the neck (8) comprises an internal “funnel” shape defining a internal conical surface (11) having a decreasing cross section in a direction towards the main body (2).

10. Container according to claim 9, characterized in that the rod (12) comprises a first section (12a) next to the closing body (4), a second section (12b) distal from the closing body (4) and a conical surface (16) arranged between the first and second section (12a, 12b); said first section (12a) presenting a cross section “A” greater than the cross section “B” of the second section (12b).

11. Container according to claim 10, characterized in that the conical surface (16) defines an inclined wall matching the conical surface (11) of the neck 8 and defining an annular contact point (17) between rod (12) and neck (8) providing a fluid-tight closure.

12. Container according to claim 8, characterized in that said neck (8) is engaged to the access opening (6) of the main body (2) by mechanical interference or by screwing.

13. Container according to the previous claim, characterized in that it further comprises a series of fibres (15) engaged with a free end (18) of the rod (12) opposite to said bottom wall (13); said fibres (15) having a greater transverse extension of the passage section (S) of the neck (8).
